(19) United States
(12) Patent Application Publication
(10) Pub. No.: US 2015/0355098 A1
(43) Pub. Date: Dec. 10, 2015

(54) ROTATING SCATTERING PLANE BASED NONLINEAR OPTICAL SPECTROMETER TO STUDY THE CRYSTALLOGRAPHIC AND ELECTRONIC SYMMETRIES OF CRYSTALS

(71) Applicant: CALIFORNIA INSTITUTE OF TECHNOLOGY, Pasadena, CA (US)

(72) Inventors: David Hsieh, San Marino, CA (US); Darius H. Torchinsky, Pasadena, CA (US)

(21) Appl. No.: 14/705,831

(22) Filed: May 6, 2015

Related U.S. Application Data
(60) Provisional application No. 61/989,056, filed on May 6, 2014.

(51) Int. Cl. G01N 21/84; G02F 1/37; G01N 21/47; G02F 1/355

(52) U.S. Cl. CPC G01N 21/84; G02F 1/3551; G02F 1/37; G01N 21/4788; G01N 2021/4709; G01N 2021/8477

(57) ABSTRACT

A method for measuring nonlinear Electromagnetic (EM) radiation emitted by a material, comprising rotating a beam of EM radiation to form a rotating beam; irradiating a surface of a material with the rotating beam at an oblique angle with respect to the surface, wherein the rotating irradiates a plurality of scattering planes in the material; and detecting nonlinear radiation emitted by the material in response to the rotating beam, such that the nonlinear radiation generated by each of the scattering planes is detected by the detector. This method opens the possibility of applying nonlinear optics as a probe of lattice and electronic symmetries on small bulk single crystals in ultra low temperature, high magnetic field or high pressure environments, which can greatly complement diffraction based techniques.

### CROSS REFERENCE TO RELATED APPLICATIONS

This application claims the benefit under 35 U.S.C. Section 119(e) of co-pending and commonly-assigned U.S. Provisional Patent Application Ser. No. 61/989,056, filed on May 6, 2014, by David Hsieh and Darius H. Torchinsky, entitled “ROTATING SCATTERING PLANE BASED NONLINEAR OPTICAL SPECTROMETER TO STUDY THE CRYSTALLOGRAPHIC AND ELECTRONIC SYMMETRIES OF CRYSTALS,” attorneys' docket number 176.107-US-P1 (CIT-6892-P), which application is incorporated by reference herein.

### STATEMENT REGARDING FEDERALLY SPONSORED RESEARCH AND DEVELOPMENT

This invention was made with government support under W911NF-13-0059 and W911NF-13-1-0293 awarded by the Army Research Office. The government has certain rights in the invention.

### BACKGROUND OF THE INVENTION

1. Field of the Invention

This invention relates to a method and apparatus for measuring nonlinear Electromagnetic radiation emitted by a material.

2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

Determining the symmetry of a crystalline solid and its underlying ordered electronic phases is essential for understanding its macroscopic mechanical, electrical and magnetic properties [1,2]. X-ray [3], neutron [4], and electron diffraction [5] have powerful complementary abilities to probe lattice, magnetic, and charge symmetries, while resonant X-ray diffraction has demonstrated sensitivity to even more exotic types of symmetry involving ordered orbital [6] and higher multipolar degrees of freedom [7,8]. However, an accurate symmetry assignment, which relies on being able to perform a unique fit to a diffraction pattern, is not always possible. Technical obstacles include not having a sufficient number of Bragg peaks owing to a finite instrument momentum range; spurious peaks arising from multiple scattering events, parasitic phases or microscopic domains in a crystal; the presence of elements with strong absorption or weak scattering cross-sections; and the unavailability of large single crystals comparable with the probe beam size.

Nonlinear optical generation [9,10] is an alternative non-diffraction based technique for determining the symmetries of the lattice and ordered electronic (electric or magnetic) phases of a crystal. This approach is based on Neumann's principle, which dictates that a tensor representing any physical property of a crystal must be invariant under every symmetry operation of its lattice or underlying electronic order [1,2]. These conditions of invariance establish a set of relationships between tensor components that reduce the number that are non-zero and independent. The structure of a tensor response therefore embeds the symmetries of a crystal, with higher rank tensors allowing for more accurate levels of refinement. Nonlinear optical susceptibility tensors are particularly useful because they are sensitive to both lattice [11,12] and electronic symmetries [13-16] and because tensors of arbitrary rank can be probed through successively higher nonlinear harmonic generation (NHG) processes in a crystal. Moreover, it offers several unique capabilities compared with diffraction based probes including micron scale spatial resolution and bulk versus surface selectivity [17,18].

For example, a nonlinear harmonic generation rotational anisotropy (NHG-RA) measurement is typically carried out to determine the structure of a nonlinear optical susceptibility tensor, which involves recording the intensity of high harmonic light generated from a crystal as it rotates about some crystalline axis. However, several technical challenges associated with maintaining precise optical alignment from a rotating sample have so far precluded such experiments from being performed on small bulk single crystals and under extreme sample environments such as ultra low temperature, high magnetic field, or externally imposed strain.

### SUMMARY OF THE INVENTION

One or more embodiments of the present invention describe the design, construction and operation of a novel NHG-RA spectrometer that can overcome all these challenges through a rotation of the scattering plane as opposed to the sample. Our setup opens the way to apply NHG-RA to a broad range of materials, including many d- and f-electron based strongly correlated electron systems, which are typically only available in small bulk single crystalline form. Moreover, one or more embodiments of the invention allow measurements to be performed in ultra low temperature optical cryostats and under static magnetic or strain fields. Thus, the present invention can be used to characterize temperature, magnetic field or pressure driven complex electronic phases in strongly correlated d- andf-electron systems.

In one or more embodiments, the technique can be generalized to an imaging modality to understand crystallographic and electronic domains and can be utilized for time-resolved pump-probe experiments.

One or more embodiments of the invention disclose a method for measuring Electromagnetic (EM) radiation scattered by a material, comprising rotating one or more beams of EM radiation to form one or more rotating beams; irradiating a surface of a material with the one or more rotating beams at one or more oblique angles with respect to the surface, wherein the rotating of each the beams irradiates a plurality of scattering planes in the material; and detecting, in a detector, radiation scattered by the material in response to the one or more rotating beams.

The radiation scattered by the material can be generated by one or more nonlinear processes.

The detecting can comprise rotating a detector such that the radiation generated by each of the scattering planes is detected by the detector.

The method can be performed while the material is stationary.

The method can further comprise polarizing the one or more beams such that at least two polarization directions of the beam are selected and such that the radiation is detected for each of the polarization directions.

The one or more rotating beams can draw at least a portion of a cone and the detector is rotated to track the displacement of the nonlinear radiation.

The method can further comprising diffracting EM radiation, using one or more diffraction gratings, to form the one or more beams comprising one or more diffracted beams of radiation, wherein the rotating comprises rotating the one or more diffraction gratings such that the one or more rotating beams comprise one or more rotating diffracted beams.

The one or more beams can be rotated such that beam walk on the material is 1 μm or less and deviation of the surface's normal away from the rotation axis is 0.2° or less when the one or more beams are rotated through 360°.

The surface can have a surface area of 1 mm by 1 mm or less.

The method can further comprise scanning the one or more beams to one or more locations on the material and illuminating the surface with the one or more rotating beams at one or more of the locations, thereby detecting the radiation generated at one or more of the locations.

The material can be at least one material selected from a transition metal oxide, a semiconductor wafer, graphene, a transition metal dichalcogenide, and a d and f electron based strongly correlated electron system.

The material can be a semiconductor wafer, the radiation scattered by the material can be generated by one or more nonlinear processes, and the radiation can be used to differentiate between crystallographic domains in the semiconductor wafer.

The material can include graphene or the transition metal dichalcogenide, the radiation scattered by the material can be generated by one or more nonlinear processes, and the radiation can be used to differentiate between different crystallographic stacking order in the graphene or the transition metal dichalcogenide.

One or more embodiments of the invention disclose an apparatus for measuring Electromagnetic (EM) radiation scattered by a material, comprising one or more optical elements, wherein the optical elements rotatably deviate EM radiation from one or more EM sources to form deviated EM radiation; and a focusing optical element positioned to focus the deviated EM radiation such that the deviated EM radiation irradiates a plurality of scattering planes at a same location on or in the material to form scattered EM radiation; and wherein the scattered EM radiation can be measured.

The optical elements can be mounted on one or more rotation stages to rotatably deviate the EM radiation.

The optical elements can each comprise a series of differently oriented diffracting structures such that each of the diffracting structures generates a different deviation angle for the EM radiation to irradiate the plurality of scattering planes.

The scattering planes can comprise one or more scattering planes each defined as a plane that contains the one or more wave vectors of all incident beams of the deviated EM radiation and one or more wave vectors comprising a sum and/or difference of the wave vectors of the incident beams.

The apparatus can further comprise a detector mounted on a rotation stage, wherein the rotation stage rotates the detector such that the scattered EM radiation scattered at each of the scattering planes is detected by the detector.

The apparatus can further comprise a polarizer mounted on a rotation stage, wherein the polarizer can select at least two polarization directions of the EM radiation and the scattered EM radiation is detected for each of the polarization directions.

The one or more optical elements can be aligned such that beam walk on the material is 1 μm or less and deviation of the surface's normal away from the rotation axis is 0.2° or less when the deviated EM radiation is rotated through 360°.

One or more embodiments of the invention further disclose a method for fabricating an apparatus for measuring harmonic generation, comprising obtaining one or more optical elements comprising one or more diffracting elements, wherein the optical elements can rotatably diffract EM radiation from one or more EM sources, to form deviated EM radiation; positioning a focusing optical element to focus the deviated EM radiation such that the deviated EM radiation irradiates a plurality of scattering planes at a same location on or in the material to form scattered EM radiation; aligning the one or more diffracting elements, wherein the aligning comprises: interfering two diffracted orders of the deviated EM radiation onto the material to form an interference pattern, observing the fringe contrast of the interference pattern, and aligning the material with respect to the focusing optical element, and/or aligning the diffracting element with respect to the focusing optical element, based on the fringe contrast and in order to optimize the fringe contrast; and positioning a detector, wherein the scattered EM radiation scattered by one or more of the scattering planes is detected and measured.

### BRIEF DESCRIPTION OF THE DRAWINGS

Referring now to the drawings in which like reference numbers represent corresponding parts throughout:

FIG. 1(a) is a schematic of an NHG-RA experiment, wherein the scattering plane (light blue) is defined by the incident (red arrow) and radiated (dark blue arrow) beams, S(P)-polarization denotes an electric field pointing perpendicular (parallel) to the scattering plane, and φ is the angle that the crystalline axis x′ makes with respect to the scattering plane axis x upon rotation about the surface normal z=z′ axis.

FIG. 1(b) illustrates simulated RA patterns for a χᵢⱼₖₗ^{qee} process using arbitrary magnitudes for the independent non-zero tensor components allowed from a D₄ₕ crystallographic point group.

FIG. 2 illustrates layout of a NHG-RA experiment according to one or more embodiments of the invention, wherein a pulsed laser beam from an Optical Parametric Amplifier (OPA), which is seeded by a Ti:sapphire regenerative amplifier (Regen), passes through a polarizer (P) and waveplate (WP) and is focused by the first lens (L1) onto a phase mask (PM). A 1^{st} order diffracted beam is collimated by a second lens (L2), sent through a long-pass filter (LPF), and then focused using a reflective objective (RO) onto a sample (S) in the cryostat that is mounted on an XYZ tip-tilt stage. The reflected beam passes back through the RO and is picked off by a d-cut mirror (DM). An analyzer (A), short-pass filters (SPF), and interference filter (IF) select a polarization component of the n^{th} harmonic, which is measured with a photomultiplier tube (PMT) using lock-in detection or with a CCD camera. The scattering plane is rotated by placing the optics WP, PM, DM, A, SPF, IF, and PMT on rotation stages. To collect the images shown in FIG. 4, the beam block (B) and DM were removed and a pellicle beamsplitter was inserted between the LPF and RO to reflect both diffracted orders through a converging lens onto a CCD camera.

FIG. 3(a) illustrates a perspective schematic depiction of the NHG-RA system according to one or more embodiments of the invention. Shown here are the diffractive binary phase mask (PM), beam block (B), collimating lens (L2), Cassegrain reflective objective (RO), sample (S), d-cut mirror (DM), and photomultiplier tube (PMT). The incident and reflected beams are shown in red and blue, respectively. The dashed arrows indicate the rotating optics, with all axes of rotation coincident with the optical axis. We note that the waveplate (not shown) must also rotate to set the appropriate polarization.

FIG. 3(b) illustrates a perspective view of only the PM and L2 showing two different rotation angles of the PM, according to one or more embodiments of the invention. In position PM (PM′), +1(+1′) and 31 1(−1′) orders are diffracted and collimated.

FIG. 4(a) illustrates images generated through the interference of both the +1 and −1 orders (wavelength λ=800 nanometers (nm)) on the surface of a sample as the phase mask is rotated, according to one or more embodiments of the invention. Both the interference fringe spacing (˜0.9 micrometers (μm)) and the overall beam diameter (˜20 μm) show negligible changes with φ.

FIG. 4(b) illustrates superposition of the spatial Fourier transforms of images such as those shown in panel (a), according to one or more embodiments of the invention. The magnitudes of the fringe wave vectors all lie on a circle (white dotted line).

FIG. 4(c) illustrates an interference image taken near a surface defect, according to one or more embodiments of the invention, wherein the defect location relative to the beam spot is unaltered to within the precision of the CCD image, setting an upper-bound of the beam walk on the sample surface to be ˜1 μm. Note that the slight changes to the appearance of the defect between φ=90° and φ=135° is due to its three dimensional (3D) nature, which causes it to cast different shadows when it is illuminated by the laser from different angles.

FIG. 5 illustrates representative NHG-RA measurements on a Sr₂IrO₄ bulk single crystal, according to one or more embodiments of the invention, wherein (a) shows 800 nm/400 nm second harmonic generation (SHG) patterns taken at room temperature in PP geometry using two different orientations of the RO, (b) shows 1200 nm/400 nm third harmonic (THG) patterns taken at a temperature of T=77 K under PS geometry, and the RO is mounted so that the spider mount occlusion coincides with nodes in the THG pattern.

FIG. 6 illustrates an apparatus that can be used for irradiating and measuring radiation scattered by a sample, according to one or more embodiments of the invention.

FIG. 7 illustrates an apparatus that can be used for irradiating and measuring radiation scattered by a sample, according to one or more embodiments of the invention.

FIG. 8A-C illustrate intensity of light transmitted through a 45° dichroic mirror changes as a function of polarization angle, wherein FIG. 8A illustrates transmission as a function of polarization for the dichroic mirror mounted 45° in a horizontal plane, FIG. 8B illustrates transmission as a function of polarization for the dichroic mirror mounted 45° in a vertical plane, and FIG. 8C illustrates transmission as a function of polarization for one mirror mounted 45° in the horizontal plane and another mounted 45° in the vertical plane.

FIG. 9 is a photograph showing a top view of the apparatus of FIG. 7, according to one or more embodiments of the invention.

FIG. 10A shows an image captured by CCD, and FIG. 10B shows an intensity plot, taken using the apparatus illustrated in FIG. 7.

FIG. 11A-D illustrate performance of the embodiment illustrated in FIG. 2 in a scanning experiment (20 μm resolution), on a Sr₂IrO₄ sample, wherein FIG. 11A illustrates the RO illuminating the sample comprising Sr₂IrO₄ and the configuration of the Ir, Sr, and O atoms, FIG. 11B is a photograph of the sample, FIG. 11C plots representative NHG-RA measurements on the Sr₂IrO₄ for 30 regions that were tested, showing all results were identical without even the need to normalize, and FIG. 11D illustrates the locations/regions where the data in FIG. 11C was taken.

FIG. 12 illustrates second harmonic data taken for the Sr₂IrO₄ sample according to one or more embodiments of the invention.

FIG. 13 is a flowchart illustrating a method for measuring Electromagnetic (EM) radiation scattered by a material, according to one or more embodiments of the invention.

FIG. 14 is a flowchart illustrating a method for fabricating an apparatus for measuring harmonic generation, according to one or more embodiments of the invention.

FIG. 15 is a schematic illustrating an optical element, according to one or more embodiments of the invention.

FIG. 16 illustrates a scattering plane.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

Although a NHG-RA technique has been successfully used to study the lattice and magnetic structures of systems such as semiconductor surfaces, multiferroic crystals, magnetic thin films and multilayers, challenging technical requirements have prevented its application, for example, to the plethora of complex electronic phases found in strongly correlated electron systems. These requirements include an ability to probe small bulk single crystals at the micron length scale, a need for sensitivity to the entire nonlinear optical susceptibility tensor, oblique light incidence reflection geometry and incident light frequency tunability among others. These measurements are further complicated by the need for extreme sample environments such as ultra low temperatures, high magnetic fields or high pressures. One or more embodiments of the invention present a novel experimental construction using a rotating light scattering plane that meets all the aforementioned requirements. We demonstrate the efficacy of our scheme by making symmetry measurements on a micron scale facet of a small bulk single crystal of Sr,IrO, using optical second and third harmonic generation.

Nonlinear Harmonic Generation in Crystals

In this section, we introduce the theoretical background to nonlinear harmonic generation (NHG) responses and their relationship to the structural and electronic symmetries of a crystal.

Nonlinear harmonic generation is a process by which monochromatic light of frequency ω is converted into higher harmonics nΩ(n=2,3,4 . . . ) through its nonlinear interaction with a material [9,10]. In general, the oscillating electric \vec{E}(ω) and magnetic \vec{H}(ω) fields of incident light can induce oscillating electric dipole \vec{P}(nω), magnetic dipole \vec{M}(nω), electric quadrupole \vec{Q}(nω), or even higher order multipole densities in a material that act as sources of higher harmonic radiation. Each NHG process is governed by a specific nonlinear optical susceptibility tensor [symbol] of the material. For example, magnetic dipole second harmonic generation induced via one interaction with both the incident electric and magnetic fields would conventionally [15] be expressed as Mᵢ(2ω)=χᵢⱼₖ^{mem} Eⱼ(ω)Hₖ(ω), where the first superscript denotes the magnetic dipole (m) origin of the induced source, the second and third superscripts denote the electric (e) and magnetic (m) nature of the driving fields, and the subscripts denote the polarization components.

Microscopically the nonlinear optical susceptibility tensor is expressed via terms such as

$${X}_{ijk}^{mem} ∝ {\sum }_{g , n , {n}^{′}} [ \frac{〈 g \vert {M}_{i} \vert n 〉 〈 n \vert {P}_{j} \vert {n}^{′} 〉 〈 {n}^{′} \vert {M}_{k} \vert g 〉}{( 2 ω - {ω}_{ng} ) ( ω - {ω}_{{n}^{′} g} )} + … ] {f}_{g} \qquad ( 1 )$$

which describes a two-photon absorption process driven by a magnetic dipole transition from the initial |g> to intermediate state |n′>, and an electric dipole transition from the intermediate |n′> to final state |n>, followed by a frequency doubled one-photon emission process driven by a magnetic dipole transition from |n> back to |g>[15]. The energy difference between the initial and intermediate or final states is given by ω_{n′g} or ω_{ng}, respectively, and f_{g} is the Fermi distribution function for state |n′>.

Neumann's principle is applied to [symbol] by enforcing invariance under transformations that respect both the lattice and electronic symmetries of the crystal, which reduces the number of independent non-zero tensor components. Further reductions can be made for experiments using a single incident beam by exploiting the permutation symmetry of the incident fields. The lattice and electronic symmetries can therefore in principle be resolved by measuring all components of [symbol] using frequencies tuned both to and away from optical transitions involving states undergoing electronic ordering.

Conventional NHG-RA System Design

In this section, we describe the capabilities and technical limitations of existing NHG-RA setups.

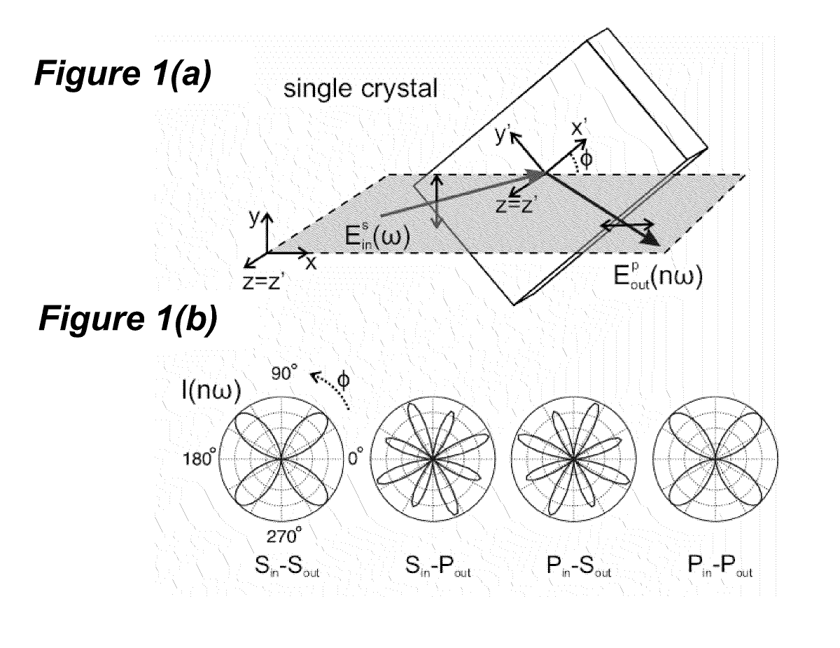

In practice, the components of [symbol] are measured using a NHG-RA technique where the intensity of high harmonic radiation emitted from a crystal is measured as a function of the angle φ subtended between the light scattering plane and the crystalline axes (FIG. 1(a)). Rotational anisotropy (RA) patterns measured using different combinations of incident and radiated light polarization (FIG. 1b) and different crystal faces probe distinct combinations of tensor components. Therefore, a collection of RA patterns is typically required to completely determine the structure of [symbol] . Depending on whether the incident and radiated frequencies are tuned off or on resonance with electronic transitions involving states participating in the electronic order, the tensor structure will be primarily representative of the lattice or electronic symmetries, respectively.

To date, NHG-RA experiments have largely been conducted using one of two schemes. In the first scheme, light is normally incident on a crystal face and the transmitted high harmonic radiation is measured. The advantage of this geometry is that RA patterns can be obtained by simply rotating the selected polarizations of the incident and radiated beams, while keeping the crystal stationary. This scheme has proven particularly conducive to studying the symmetry of magnetic [19-22] and multiferroic order [23,24] in thin transparent crystals. It has also been applied to study the lattice structure of opaque crystals by measuring the retro-reflected high harmonic radiation [25-28]. However a limitation is that no incident field component can be introduced perpendicular to the crystal surface, which greatly reduces the number of accessible tensor components.

The second scheme utilizes an oblique reflection geometry where the polarizations of the incident and reflected beams are held fixed while the crystal is rotated (FIG. 1(a)) to collect an RA pattern. However this requires aligning an optically flat region of the crystal to coincide and lie normal to a manipulator rotation axis, which in turn must be made to lie in the light scattering plane. Owing to the limited number and precision of mechanical degrees of freedom on a typical cryostat manipulator, this scheme is only applicable to thin films [29-33] or bulk single crystals that have several mm large naturally cleaving [34] or mechanically polished [35] flat areas. Experiments can be simplified by rotating the polarizations of the incident and radiated light while keeping the crystal stationary [36,37], although this can restrict the number of accessible tensor components because the scattering plane stays fixed with respect to the crystalline axes.

Technical Requirements for One or More Embodiments of NHG-RA

A challenging combination of technical requirements have so far prevented NHG-RA from being widely applied to the study of complex low temperature electronic phases. These include the following: i) Experiments must be performed in reflection geometry because the thickness of bulk single crystals typically exceeds the penetration depth of light, especially at inter-band resonance frequencies. Moreover, efficient cooling of bulk crystals in a vacuum cryostat is achieved by adhering the back crystal surface onto a cold finger, which precludes transmission based experiments. ii) Obliquely incident and reflected light must be used in order to have sensitivity to all tensor components. This requires the crystal surface normal to be aligned exactly parallel to the rotation axis so as to maintain a constant angle of incidence. This is important because the nonlinear optical conversion efficiency is sensitive to the angle of incidence, and because the reflected beam should not precess with φ in order for it to remain stationary on the photo detector active area, which can often have a position dependent sensitivity. iii) Typical bulk single crystals of correlated electron materials may be very small (<1 mm), spatially inhomogeneous and multi-faceted. To probe a small, locally flat and clean region of the crystal, that region must be made to lie exactly on the rotation axis and be coincident with the beam focus in order to avoid beam walking away from the region. That region must also be oriented normal to the rotation axis for reasons already discussed. In addition to being an alignment challenge, this would also require a cryostat manipulator with many mechanical degrees of freedom, which greatly limits the base temperature that can be reached. iv) For low temperature experiments that require low optical fluence, high harmonic signals need to be enhanced using pulsed lasers with tunable wavelength to exploit resonance conditions (eqn. 1). v) Experiments that require directing an external magnetic or strain field along a particular crystallographic direction are complicated by the need to rotate the field together with the crystal, which requires expensive vector magnets or rotatable strain apparatus.

Experimental System Design

In this section, we describe the design and construction of a NHG-RA spectrometer according to one or more embodiments of the invention, a novel design for performing wavelength tunable NHG-RA measurements under oblique incidence geometry that meets the aforementioned technical requirements. Our scheme works by rotating the light scattering plane while keeping the crystal stationary, and demonstrates both negligible beam walk on the crystal (≦1 μm) and negligible deviation (≦0.2°) of the crystal surface normal away from the rotation axis over the entire 360° angular φ range. This opens the possibility of applying NHG-RA to small bulk single crystals and the study of their crystallographic and electronic symmetries and domain structures at ultra low temperatures, high magnetic fields and strain fields.

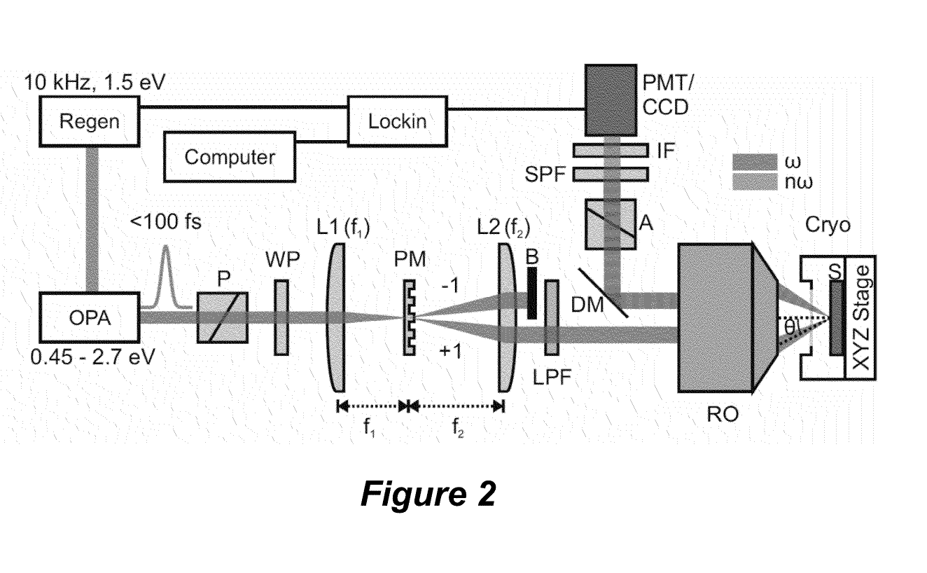

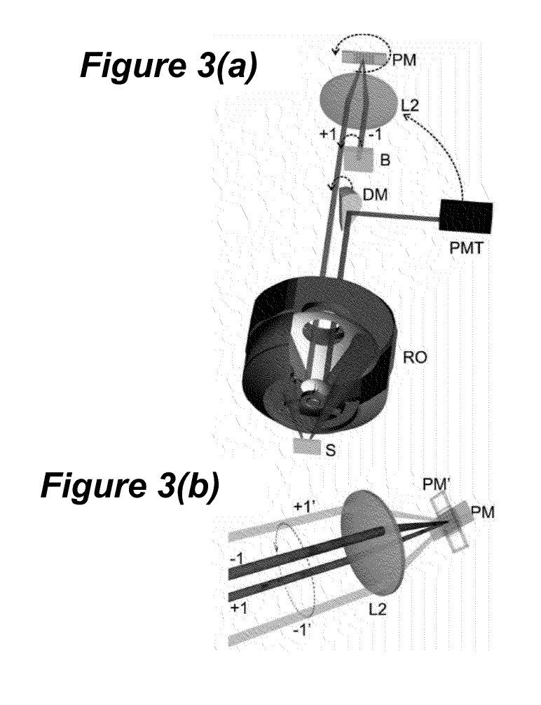

FIGS. 2 and 3 depict an NHG-RA system according to one or more embodiments of the invention, which is similar to the 4f optical setups used for transient grating spectroscopy[38]. One or more embodiments used a regeneratively amplified Ti:sapphire laser system (KM Labs Wyvern-1000) producing 35 fs duration 1 mJ pulses centered at a wavelength of 800 nm and operating at a 10 kHz repetition rate. A pulsed laser source is exploited for its high peak fields owing to the typically low NHG efficiency of materials. For the 800 nm/400 nm second harmonic generation experiments, less than 1 mW (100 nJ/pulse) average incident power was used in order to avoid photoinduced sample damage. When operating at other wavelengths, the full laser power pumped an optical parametric amplifier (OPA; Continuum Laser Palitra), allowing access to wavelengths ranging from approximately 500 nm to 3 μm with pulse duration roughly matching that of the driving laser field. The output beam was attenuated by reflection from a 10° wedge prism, which provided a large (˜97%) ghost free reduction of the laser power without introducing unwanted pulse broadening effects. The beam was then further attenuated by reflective neutral density filters to avoid sample damage and then delivered to the apparatus described below.

The beam first passes through a Glan Taylor or nanoparticle polarizer (P) and then an achromatic half-waveplate (WP). It is then focused by a planoconvex lens (L1) onto a custom fused silica binary phase mask (PM—Tessera), which diffracts it equally into +1 and −1 orders, at an angle ψ relative to the optical axis, given by Λ_{PM=λ/}2 sin(λ) where λ is the incident wavelength and Λ_{PM} is the feature size on the PM. An array of feature sizes adapted for different incident wavelength ranges are available on our PM. Both diffracted orders are simultaneously collimated and brought parallel to each other by an achromatic doublet (L2), which was chosen for both its reduced chromatic and optical abberations over the wavelength range of the incident light. One order is then blocked by a beam block (B) while the other passes through a longpass filter (LPF) to block parasitic higher harmonics. The final optical element in the light incidence path is a 15×, infinite back focal length Cassegrain reflective objective (RO) with a UV-enhanced Al coating that serves to focus the light onto the sample without chromatic dispersion, spherical abberation, coma and astigmatism, significantly loosening the alignment tolerances of this component of the experiment. This optic also provides a large numerical aperture (NA=0.5), yielding an oblique incidence angle of θ˜30° onto the sample at a working distance of 25 mm, which exceeds the minimum working distance of our optical vacuum cryostat (Janis ST-500). The optical cryostat is mounted on a custom stage with XYZ translational and tip-tilt angular degrees of freedom for sample alignment.

The fundamental and higher harmonic beams reflected from the sample all follow an equal path back through the RO that is diametrically opposite from the incident beam since the RO is free of chromatic dispersion and abberation for all wavelengths used. A d-cut silver coated pick-off mirror (DM) steers the reflected beams through a high contrast ratio analyzer (A) to select either the P or S output polarization (see FIG. 1(a) for the definition of S and P polarization), which is then spectrally filtered using two consecutive shortpass filters (SPF) and an interference filter (IF) at the desired harmonic frequency, and finally the filtered reflected beam is directed into a photomultiplier tube (PMT). We note that a beam diffuser can be placed just before the PMT to more uniformly illuminate the PMT active area. The intensity is detected by terminating the output current of the PMT across a 50 kΩ resistor and inputting to a lock-in amplifier (lockin) synchronized with the repetition rate of the laser (Regen).

In order to rotate the scattering plane, a subset of the optics are placed on motorized rotation stages that share a common axis of rotation along the optical axis (stages not shown in FIGS. 2 and 3). Specifically, the WP is mounted on a dedicated rotation stage to maintain either P or S polarized incident light with respect to the rotating scattering plane; the PM is mounted on a second rotation stage such that the diffracted beams draw a cone under rotation (FIG. 3(b)); and the DM, A, SPF, IF and PMT are mounted together on a third rotation stage to track the displacement of the reflected beam. RA patterns are collected by stepping the rotation angles in finite increments (the WP stage is stepped at half increments of the other two stages) and taking measurements at each angle. Typical collection times for the data shown in the next section were on the order of 45 minutes for a full (φ-dependent trace. FIG. 2 further shows a computer connected to the lockin for processing the data received from the detector.

System Performance

Performance Parameters

The optics L2 and RO comprise the two elements of a Keplerian telescope, which serves to image the laser spot on the PM onto the surface of the sample. When B is removed so that the +1 and −1 diffracted orders are allowed to recombine at the surface of the sample, the phase object of the binary mask pattern is converted into an amplitude image in the form of a sinusoidal interference pattern, whose fringe spacing Λ is related to the angle of incidence by Λ=λ/2 sin(θ). As the scattering plane and orientation of the interference fringes rotate with the PM, the amount of beam walk on the sample and any variation in the scattering angle over the 360° angular (φ range can be quantified by tracking the location of the interference pattern and the magnitude of Λ respectively.

To perform these tests, we removed B and DM and placed a pellicle beam splitter in between L2 and the RO. After being collimated by L2, both +1 and −1 diffracted orders pass through the pellicle into the RO and then converge at their focus on the sample surface. Both +1 and −1 beams then reflect off of the sample, are re-collimated through the RO, and are steered by the pellicle into an achromatic doublet that focuses them onto a CCD camera. To ensure that the area on the sample illuminated by the laser beams is oriented normal to the optical rotation axis, the reflected +1(−1) beam path is made to completely overlap the incident −1(+1) order beam path for all φ. We verify that both +1 and −1 orders independently provide the same sharp image of the sample surface and that they overlap entirely with each other on the CCD camera. Using 800 nm incident light and a phase mask feature size of Λ_{PM}=13.4 μm, we obtain 79 ˜900 nm and an overall spot size on the sample less than 20 μm at Full Width at Half Maximum (FWHM). We note that it is possible to achieve smaller spot sizes on the sample simply by decreasing the focal length of L1 to shrink the laser spot size on the PM. However, the effects of an increasingly large longitudinal field component of a focused vector Gaussian field [39, 40] should be considered when analyzing the NHG patterns.

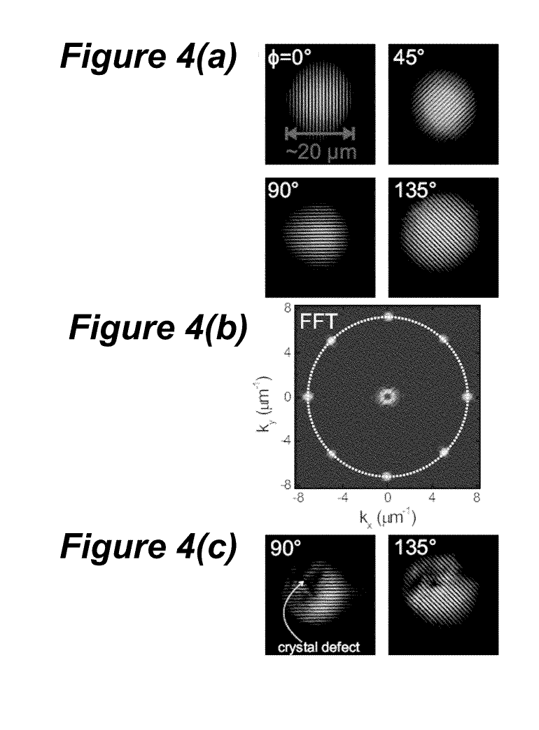

Interference patterns on the sample surface at various values of φ are shown in FIG. 4(a), which show no appreciable change in Λ. This is more clearly demonstrated by taking their Fourier transforms (FIG. 4(b)), which shows a central peak at \vec{k}=0 due to the fast Fourier Transform (FFT) of the overall beam shape and satellite peaks at |k|=7 μm¹ representing the modulation wave vector of the interference fringes. The position of the satellite peaks is carefully tracked as the scattering plane is rotated. Using the derived values of Λ, we determine its change with φ to be less than ˜0.01 μm, which corresponds to a variation in scattering angle δθ<±2°.

To determine the amount of beam walking on the sample as the scattering plane is rotated, we use the presence of defects on a sample surface to serve as a point of reference. In general we find that the location of defects are stationary relative to the edges of the interference pattern to within 1 μm as φ is varied. An example of a large defect is shown in FIG. 4(c). Taking the metrics of FIGS. 4(b) and (c) together, our NHG-RA setup features an incident beam that stays highly stationary on the sample and exhibits negligible variation in its incidence angle on the sample over the full range of φ.

One experimental inconvenience of one or more embodiments of our scheme is that the diverging reflector in the RO is suspended by a “spider” mount which occludes the beam in four angular positions separated by 90°. The angular subtense of this occlusion is ±8° in our current configuration but can be further reduced by decreasing the collimated laser beam diameter emerging from L2. To eliminate the occluded angles, we chose to mount the RO in a precision manual rotation stage. Each RA pattern is taken twice with the RO rotated to two different angles and then patched together as discussed in the next section. Alternatively, the RO can be mounted on a motorized rotation stage and simply rotated in step with the PM during data acquisition.

Typical Example of Measurement on Sr₂IrO₄

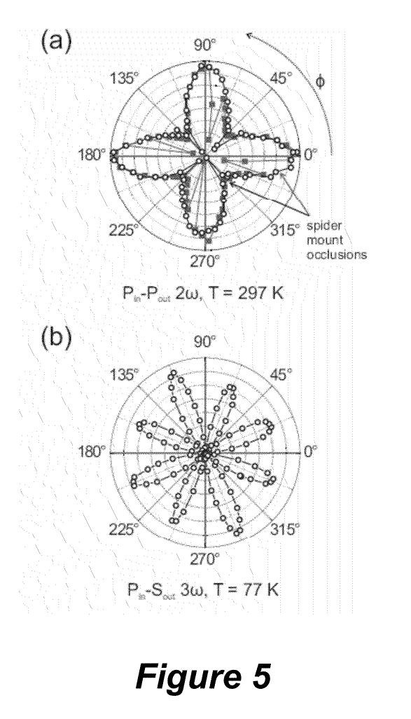

To demonstrate the power of the technique, we apply the NHG-RA setup illustrated in FIGS. 2 and 3 to study a single crystal of the 5d transition metal oxide Sr₂IrO₄. The single crystal growth methods are described elsewhere [41]. Iridates are generally difficult to study using neutron diffraction because Ir is a strong neutron absorber and bulk single crystals are typically small ≦1 mm) and may have micron scale domains [42-44]. Moreover, their cleaved surfaces are often optically flat over micron scale facets and terraces. Using our setup, we are able to collect NHG-RA data from an (001) facet of a Sr₂IrO₄ single crystal under varying polarization combinations, temperatures and wavelengths as shown in FIG. 5. Panel (a) in FIG. 5 displays room temperature second harmonic generation (SHG) 800 nm/400 nm data taken with P-polarized incident and reflected light. The signal, which originates from a bulk electric quadrupolar response χᵢⱼₖₗ^{qee}, exhibits four-fold rotational symmetry about the (001) axis as required by the Sr₂IrO₄ crystalline lattice [45,46]. Two superposed raw data sets taken at two different RO orientations are presented showing excellent reproducibility. The presence of the spider mount occlusions mentioned previously are clearly visible as sharp valleys in the RA patterns, which can be eliminated by patching together the two data sets shown.

As an example of experiments conducted under cryogenic conditions using a tunable light source, we perform third harmonic generation (THG) 1200 nm/400 nm experiment on Sr₂IrO₄ at 77 K. NHG-RA data taken with S-polarized incident and P-polarized reflected light are shown in FIG. 5b. This response originates from a bulk electric dipole process χᵢⱼₖₗ^{eeee} and the symmetry of the underlying crystalline lattice is again observed with excellent signal-to-noise contrast. In this case, the spider mount occlusions are eliminated by orienting them to coincide with the nodes in the THG pattern. The fact that all nodes approach zero indicates a negligible background noise in our data.

Alternative Embodiments

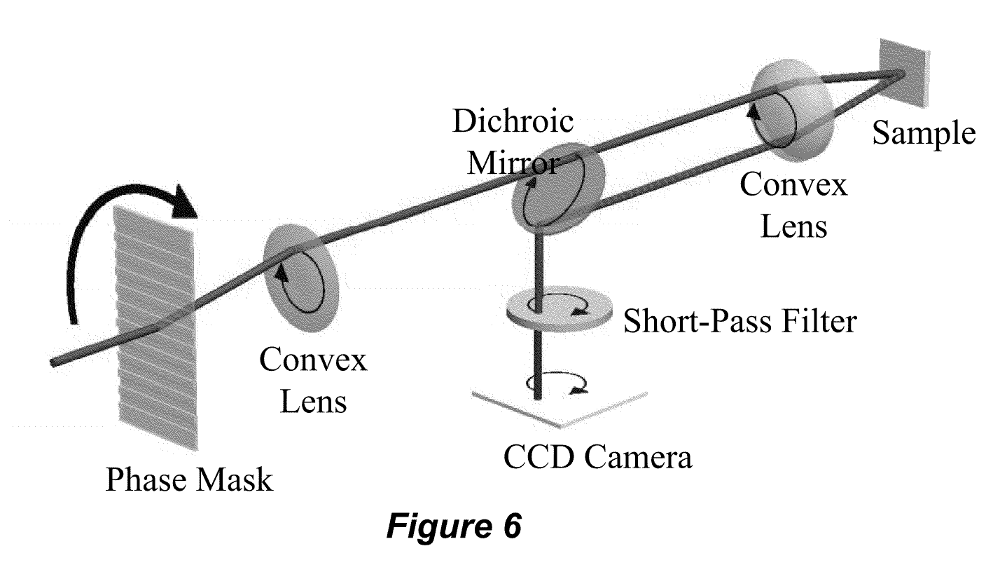

FIG. 6 illustrates an apparatus that can be used for (e.g., high speed) nonlinear optical harmonic generation rotational anisotropy measurements, according to one or more embodiments of the invention. The apparatus of FIG. 6 comprises a rotatable phase mask, a first rotatable convex lens, a rotatable dichroic mirror, a second rotatable convex lens, the sample, a rotatable short pass filter, and a CCD camera for detection. In FIG. 6, arrows indicate that the element can be rotated about its axis. The red beam is the incident beam, and the blue and red beam is the beam reflected/scattered from the sample.

The basic idea in the setup of FIG. 6 is to put a dichroic mirror in the line of the beams to deflect the signal to a detector (e.g., CCD camera) that does not have to move. In this embodiment, the dichroic mirror allows light at 800 nm to be transmitted, and reflects light at twice the frequency. Again, the scattering plane is rotated by rotating the phase mask. The beam traces out a circle on the CCD camera. In this embodiment, much less bulk needs to be rotated, so data can be collected orders of magnitude faster. In addition, we can immediately see the symmetry patterns visually. However, the incoming polarization needs to be adjusted.

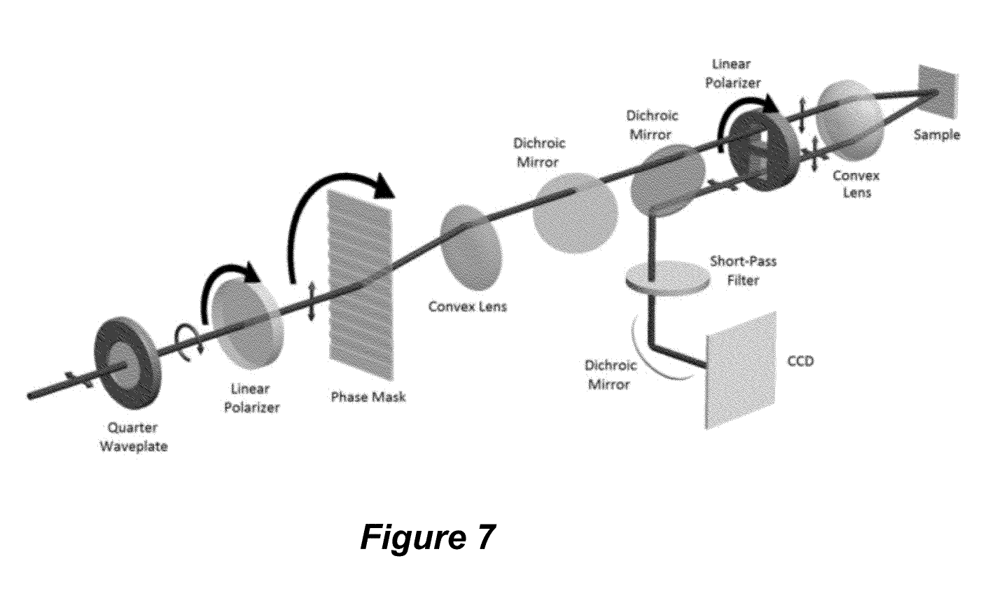

FIG. 7 shows a modification of the apparatus of FIG. 6, according to one or more embodiments of the invention, wherein the setup of FIG. 7 further comprises a quarter waveplate at the front end to create circularly-polarized light. One polarization can be selected with a linear polarizer positioned before the phase mask, wherein the linear polarizer rotates along with the phase mask. The apparatus further comprises a second linear polarizer placed between the dichroic mirror and the sample, wherein the second linear polarizer also rotates in order to select the outgoing polarization. This allows uniform polarization selection in the scattering plane, or perpendicular to it.

The apparatus further comprises two extra dichroic mirrors as compared to the apparatus of FIG. 6. This is because the dichroic mirrors, aligned at 45 degrees to the beam, are actually quite sensitive to the light's polarization. In addition, the orientation of the dichroic mirrors matters. The first two dichroic mirrors attenuate the red beam, which is polarized in some direction, by differing amounts.

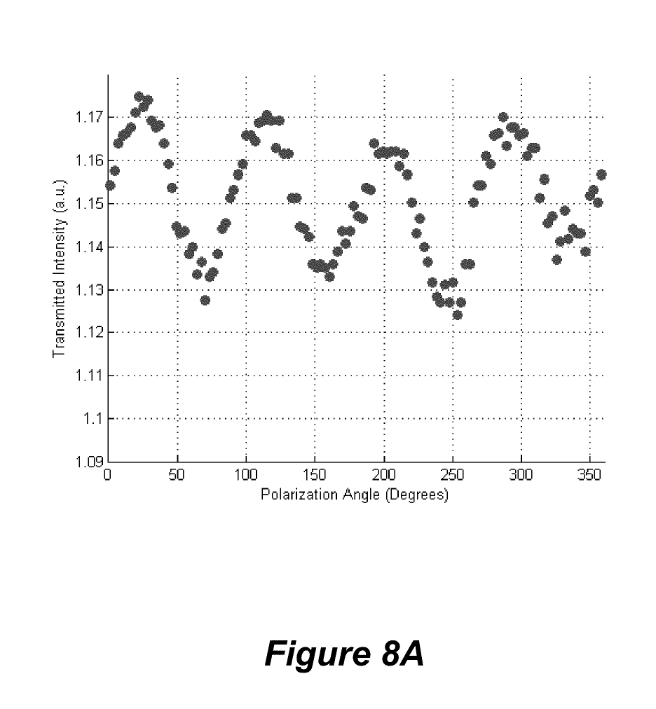

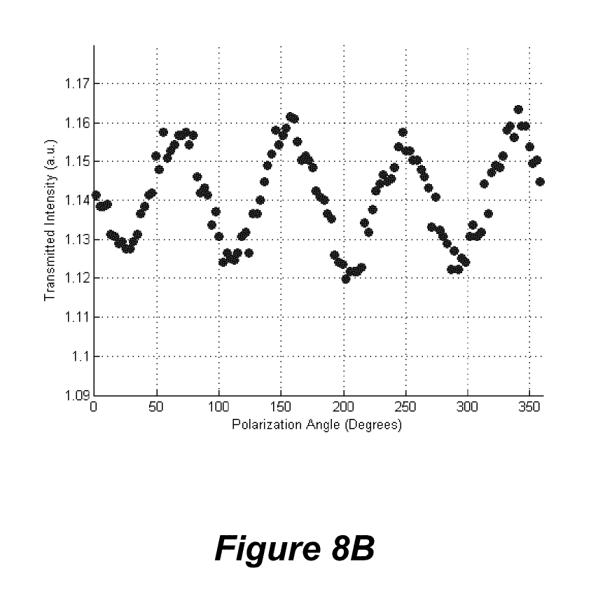

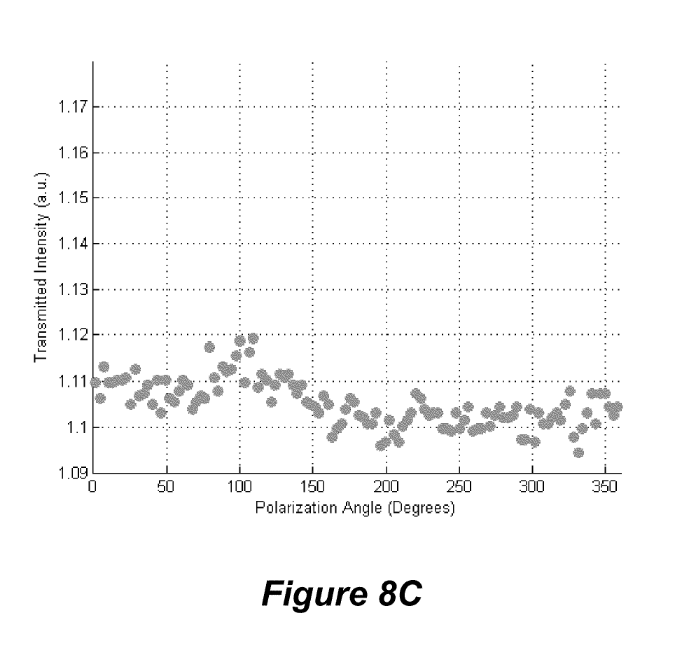

FIG. 8 illustrates the amount of light transmitted through each dichroic mirror varies roughly sinusoidally with polarization angle. FIG. 8A illustrates the transmission of 800 nm light through the first dichroic mirror (mirror mounted 45° in the horizontal plane) and FIG. 8B illustrates the transmission of 800 nm light through the second dichroic mirror (mirror mounted 45° in the horizontal plane). FIGS. 8A-8B illustrate the transmission of each of the mirrors is offset by 180 degrees.

FIG. 8C shows the polarization dependence effects can be canceled out by placing two dichroic mirrors of different orientations in each beamline. FIG. 8C shows the transmission through a pair of dichroic mirrors, where one mirror is mounted 45° in the horizontal plane and another mirror is mounted 45° in the vertical plane. All of the graphs in FIGS. 8A-C are on the same intensity scale and the variation in FIG. 8C is on the same level as typical laser noise, so we have removed completely any polarization dependence due to the dichroic mirror.

As a result, in the triple mirror geometry embodiment of FIG. 7, the incoming 800 nm light sees two dichroic mirrors, whose polarization effects cancel. The outgoing 400 nm light sees two dichroic mirrors as well, whose polarization effects cancel.

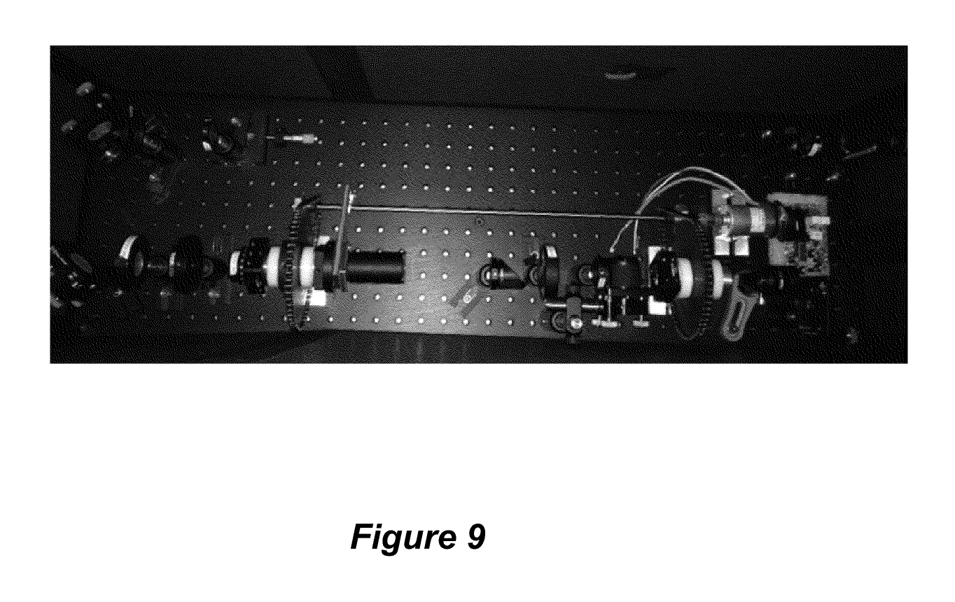

FIG. 9 is an overhead photograph of the setup of FIG. 7, illustrating that the apparatus of FIG. 7 can fit in a table space/area of 3 square feet or less. The rotators can spin at approximately 10 hertz, so full patterns can appear on the camera output immediately. If the signal is strong enough, the pattern can be seen by eye, just by holding a card in front of the camera.

Example Data Obtained Using the Embodiment of FIG. 7

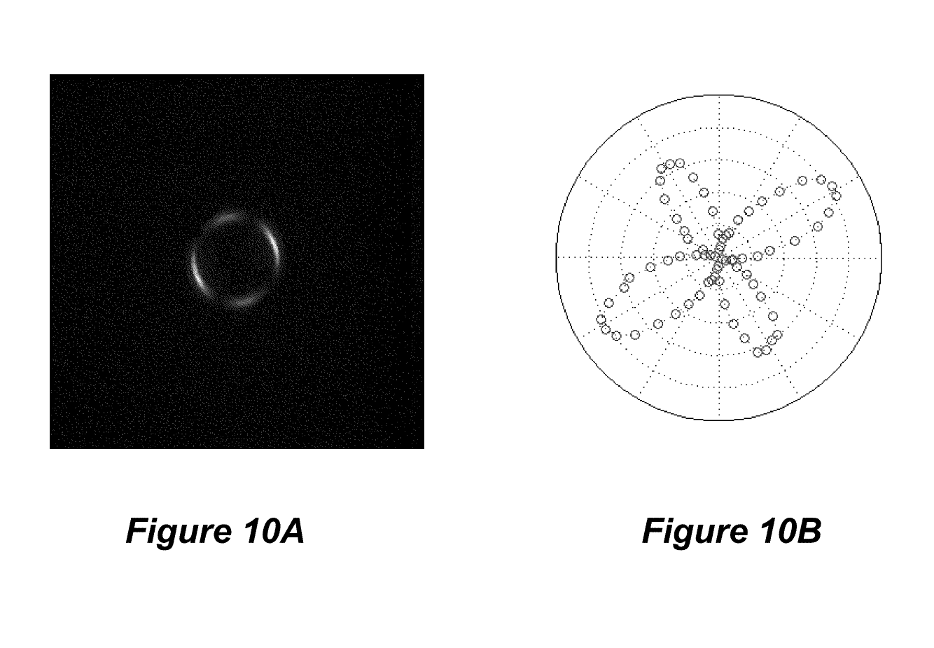

FIG. 10A-B illustrate example data from a sample comprising Gallium Arsenide (GaAs), illustrating second harmonic generation from 800 nm incoming light and the Sᵢₙ—Pₒᵤₜ signal (data taken at a sample temperature of 298 Kelvin).

FIG. 10A illustrates what is seen on the CCD as we rotate the scattering plane and becomes apparent after only a fraction of a second. This particular image was made by integrating our signal over 30 seconds. We can extract from this image the intensity as a function of angle, as illustrated in FIG. 10B. This image analysis is performed by summing up the intensity of each pixel within a certain range of angles. To generate the plot in FIG. 10B, the image analysis script runs for only a couple of seconds.

Data of similar fidelity takes up to an hour to collect using one or more embodiments of the apparatus illustrated in FIG. 2. One or more embodiments of the apparatus in FIG. 2 have a rotation frequency of 10⁻³ Hertz (Hz). Using one more embodiments of the apparatus illustrated in FIG. 7, on the other hand, rotation frequency can be10 Hz, noise can be reduced (e.g,. 1/f noise can be reduced), enabling faster data collection. This is important for some samples, which may naturally reconstruct on the order of an hour.

In addition, we can add spatial resolution by adding an adjustable lens somewhere before the setup. We could use this to target specific domains for data collection.

One or more embodiments of the invention can be implemented as an ultrafast time-resolved measurement by adding a pump beam. It is possible to do pump-probe measurements using the setup of FIG. 7, simply by introducing a pump beam and delay stage.

One or more embodiments can be implemented as a spatially-resolved measurement by scanning.

Scanning Embodiment

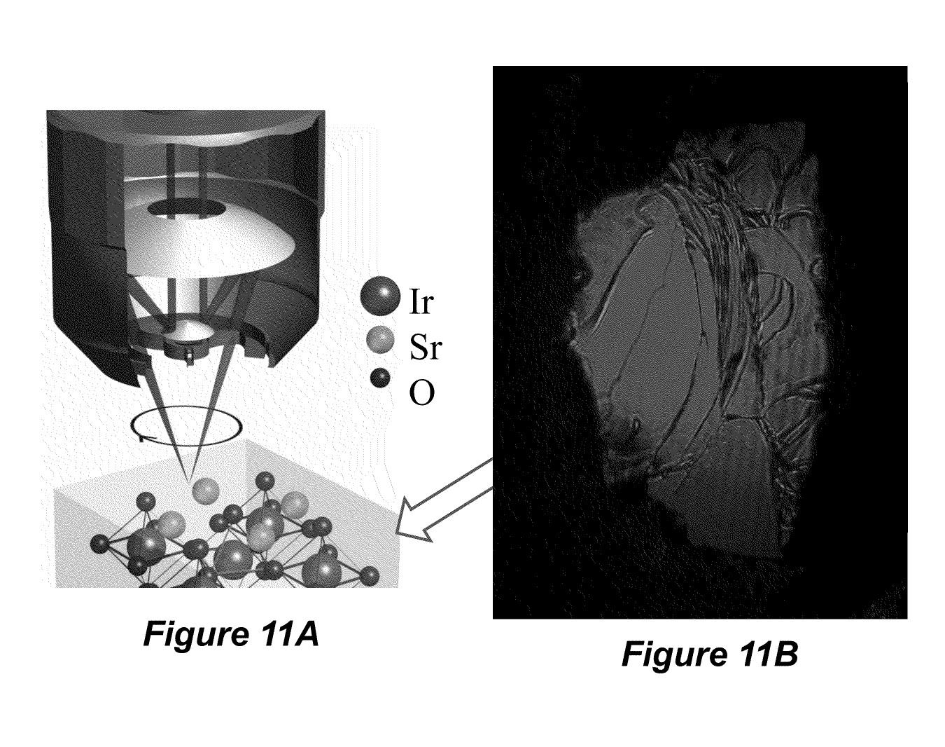

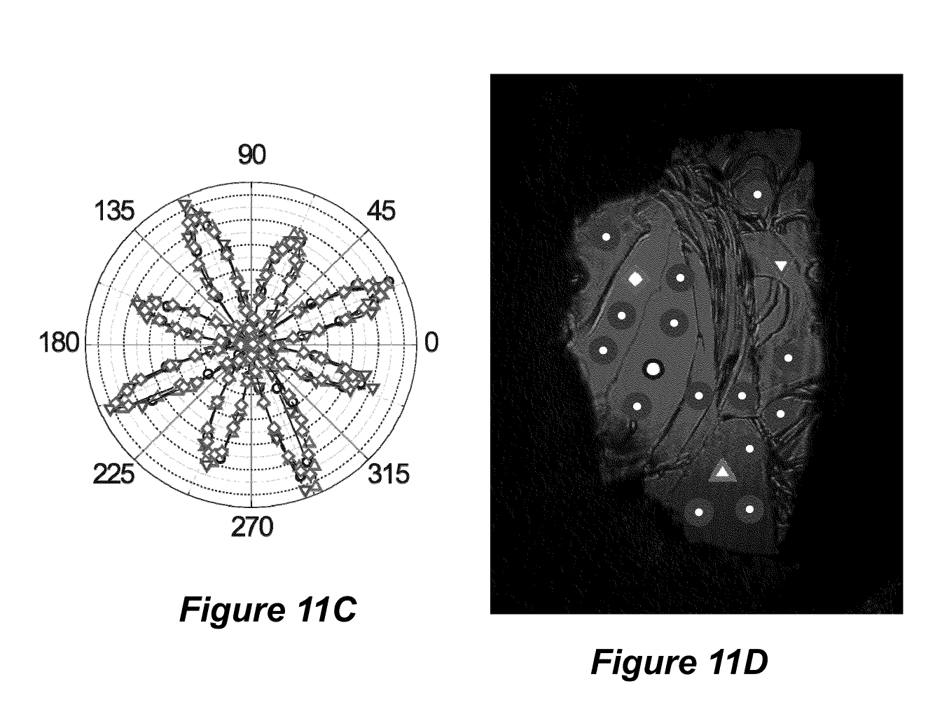

FIG. 11A-D illustrate performance using the apparatus in FIG. 2 in a scanning experiment (20 μm resolution), on a Sr₂IrO₄ sample, wherein FIG. 11A illustrates the RO illuminating the sample comprising Sr₂IrO₄ and the configuration of the Ir, Sr, and O atoms, FIG. 11B is a photograph of the sample, FIG. 11C plots representative NHG-RA measurements on the Sr₂IrO₄ for 30 regions that were tested, showing all results were identical without even the need to normalize, and FIG. 11D illustrates the locations/regions where the data in FIG. 11 C was taken.

Further Data

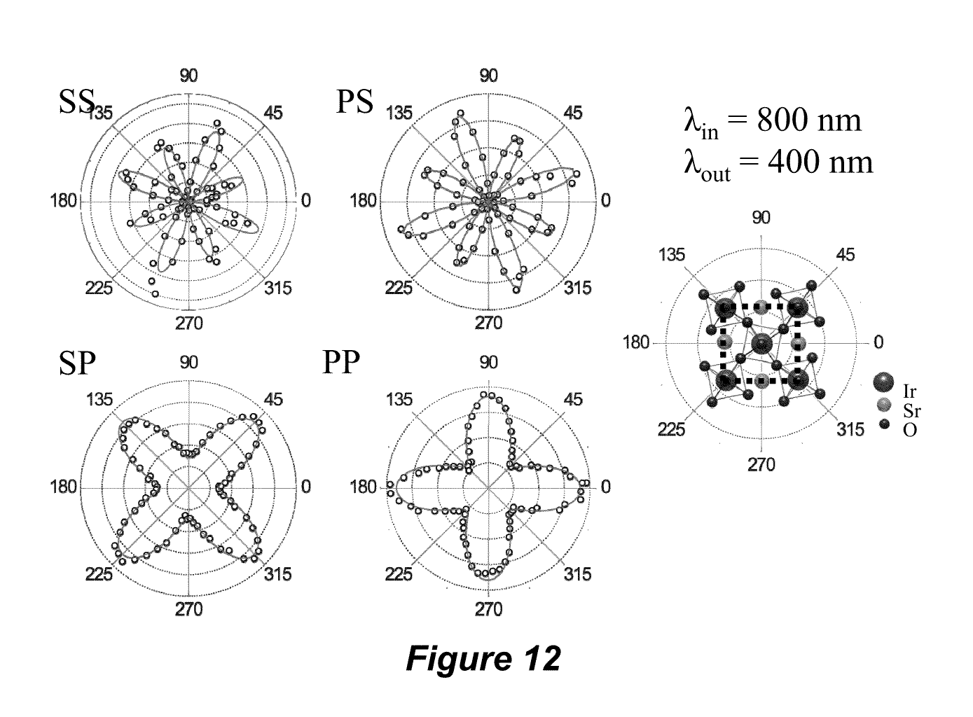

FIG. 12 illustrates second harmonic data taken for the Sr₂IrO₄ sample.

Process Steps

Irradiation Method

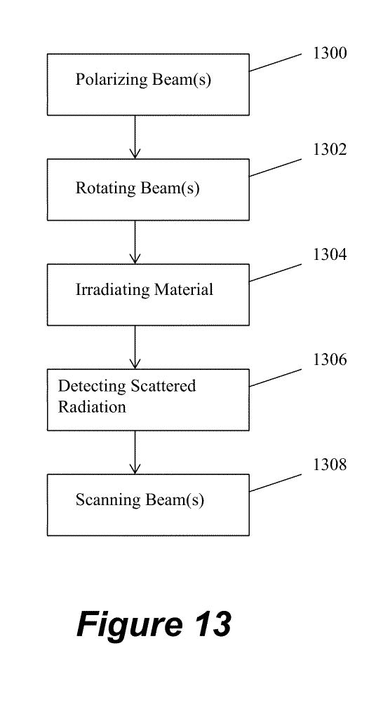

FIG. 13 illustrates a method for measuring Electromagnetic (EM) radiation scattered by a material, according to one or more embodiments of the invention. For example, the method can be a method of performing a nonlinear harmonic generation rotational anisotropy (NH-GRA) measurement.

Block 1300 represents polarizing one or more beams of EM radiation. The one or more beams can comprise different wavelengths, for example.

Block 1302 represents rotating the one or more beams of EM radiation to form one or more rotating beams.

Block 1304 represents irradiating a surface of a material with the one or more rotating beams at one or more oblique angles with respect to the surface, wherein the rotating of each the beams irradiates a plurality of scattering planes in the material. The step can comprise diffracting EM radiation, using one or more diffraction gratings, to form the one or more beams comprising one or more diffracted beams of radiation, wherein the rotating comprises rotating the one or more diffraction gratings such that the one or more rotating beams comprise one or more rotating diffracted beams.

The surface of the material can include a surface area of 1 mm by 1 mm or less.

The one or more beams can be rotated such that beam walk on the material is 1 μm or less and deviation of the surface's normal away from the rotation axis is 0.2° or less when the one or more beams are rotated through 360°.

Block 1306 represents detecting, in a detector, radiation scattered by the material in response to the one or more rotating beams. The radiation scattered by the material can be generated by one or more nonlinear processes. The detecting can comprise rotating a detector such that the radiation generated by each of the scattering planes is detected by the detector.

The method can be performed while the material is stationary. At least two polarization directions of the one or more beams can be selected such that the radiation scattered by each of the scattering planes is detected for each of the polarization directions.

The one or more rotating beams can draw at least a portion of a cone and the detector can be rotated to track the displacement of the radiation scattered by the scattering planes.

Block 1308 represents scanning the one or more beams to one or more locations on the material and illuminating/irradiating the surface with the one or more rotating beams at one or more of the locations, thereby detecting the radiation generated at one or more of the locations.

The material can be at least one material selected from a transition metal oxide, a semiconductor material or wafer, graphene, a transition metal dichalcogenide, and a d and f electron based strongly correlated electron system. The d and f electron based strongly correlated electron system can be a system that absorbs neutrons strongly.

For example, the material can be a semiconductor wafer and the (e.g., nonlinear) radiation scattered by each of the scattering planes can be used to differentiate between crystallographic domains in the semiconductor wafer.

For example, the material can include graphene or a transition metal dichalcogenide, and the (e.g., nonlinear) radiation scattered by each of the scattering planes can be used to differentiate between different crystallographic stacking order in the graphene or the transition metal dichalcogenide. The stacking can include the stacking of two dimensional sheets and differentiating orientation of sheets with respect to one another.

One or more wavelengths (and plurality of wavelengths at once) of the EM radiation and/or a rotation of the beam can be such that the nonlinear radiation is used to measure a crystallographic and/or electronic symmetry of the material comprising a crystal.

Fabrication Method

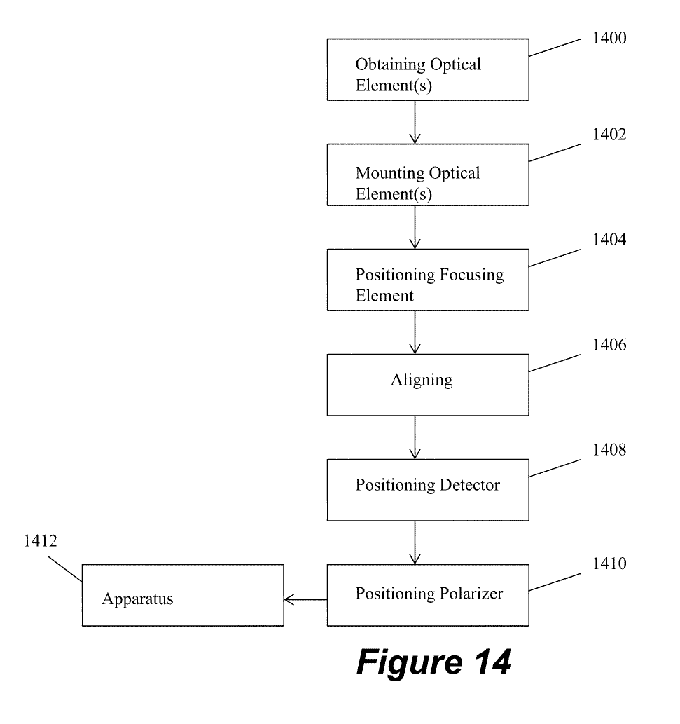

FIG. 14 illustrates a method for fabricating an apparatus for measuring radiation scattered by a material, according to one or more embodiments of the invention.

Block 1400 represents obtaining or fabricating one or more optical elements (e.g., comprising one or more diffracting elements, one or more spatial light modulators, one or more modulation devices, one or more deformable mirror devices, or one or more wedge prisms) wherein the optical elements can rotatably deviate (e.g,. diffract) EM radiation from one or more EM sources (e.g., laser), to form deviated EM radiation.

The optical elements can comprise a series of differently oriented diffracting structures that diffract the EM radiation such that each of the diffracting structures generates one or more different deviation angles θ and/or Φ φ (referring to FIGS. 1 and 2) for the EM radiation, thereby irradiating the plurality of scattering planes in the material. The diffracting structures (e.g., slits) can be lithographically and/or digitally generated, and can have different sizes (e.g., grating/slit spacing) for different wavelengths.

Block 1402 represents mounting the optical elements.

For example, the optical elements can be mounted on one or more rotation stages to rotatably deviate the EM radiation from one or more EM sources.

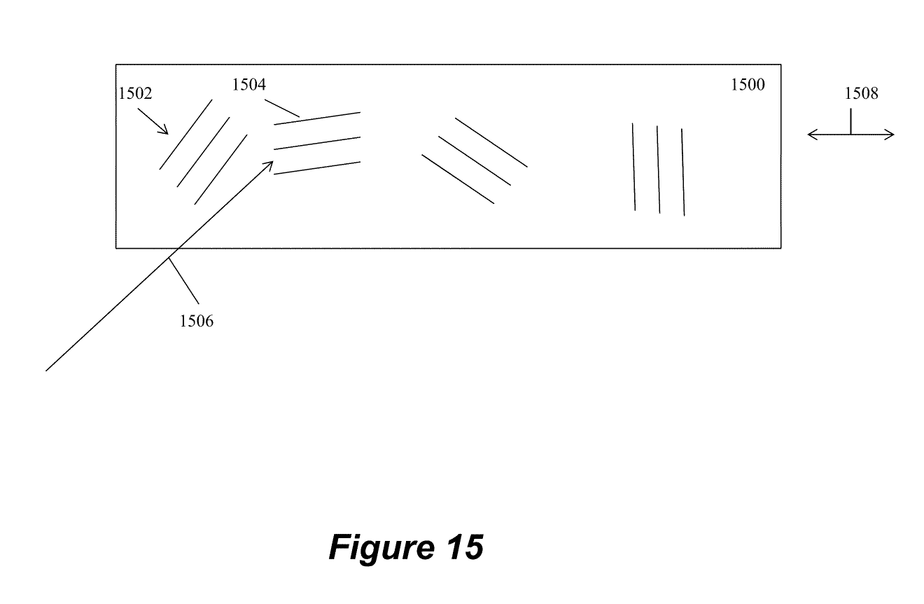

For example, the optical element 1500 comprising differently oriented sets 1502 of diffraction structures or slits 1504 can be mounted such that the beam of EM radiation 1506 can be translated 1508 to each the differently oriented diffraction structures 1502, so that the beam is rotatably deviated (each differently oriented diffraction structure 1502 can produce a deviated beam (diffracted beam) rotated by a different amount θ and/or Φ or φ, FIG. 1 or 2), as illustrated in FIG. 15.

Block 1404 represents positioning a focusing optical element to focus the deviated EM radiation such that the deviated EM radiation irradiates a plurality of scattering planes at a same location on or in the material.

For example, the one or more diffraction gratings can be positioned and mounted a on a rotation stage, wherein the diffraction grating(s) diffract EM radiation to form diffracted EM radiation, the rotation stage rotating the diffraction grating to form one or more rotating beams of the diffracted EM radiation, the rotating beams focused by the focusing optical element to irradiate a surface of a material at an oblique angle with respect to the surface and to irradiate a plurality of scattering planes in the material.

For example, a translation stage can translate the differently oriented diffraction gratings/structures, or the EM radiation, into a path of the EM radiation, to form one or more rotating beams of the diffracted EM radiation, the rotating beams focused by the focusing optical element to irradiate a surface of a material at an oblique angle with respect to the surface and to irradiate a plurality of scattering planes in the material.

Block 1406 represents aligning the one or more optical elements (e.g., diffracting elements), wherein the aligning comprises interfering two diffracted orders of the EM radiation onto a material to form an interference pattern, observing the fringe contrast of the interference pattern, and aligning the material with respect to the focusing element, and/or aligning the optical element with respect to the focusing element, based on the fringe contrast and in order to optimize the fringe contrast.

The optimizing can comprise maximizing fringe contrast uniformly over the overlap of the two diffracted orders on the material, or maximizing or increasing the number of fringes observed over the area covered by the two diffracted orders on the material.

The mounting and aligning of the diffraction grating can be such that beam walk on the material is 1 μm or less and deviation of the material's surface normal away from the rotation axis is 0.2° or less when the beam is rotated through 360°.

Block 1408 represents mounting and positioning a detector. The detector can be mounted on a rotation stage, e.g., for detecting nonlinear optical radiation emitted by the material in response to the rotating beam, wherein the rotation stage rotates the detector such that the radiation scattered at each of the scattering planes is detected by the detector.

Block 1410 represents positioning and mounting a polarizer on a rotation stage, wherein the polarizer can select at least two polarization directions of the EM radiation and the scattered radiation is detected for each of the polarization directions. The polarizer can rotate the incoming polarization to coincide with the scattering plane.

Block 1412 represents the end result, an apparatus for measuring EM radiation scattered by a material, comprising one or more optical elements (e.g., phase mask PM), wherein the optical elements rotatably deviate EM radiation (e.g., red beam having frequency ω in FIGS. 2, 6, and 7) from one or more EM sources (e.g., OPA and Regen); and a focusing optical element (e.g., RO or convex lens) positioned to focus the deviated EM radiation (e.g., +1 order in FIG. 2) such that the deviated EM radiation (e.g,. red beam having frequency ω in FIG. 2, 6, or 7) irradiates a plurality of scattering planes at a same location on or in the material to form scattered EM radiation (e.g,. blue and red beam in FIG. 2, 6, or 7). The optical element can produce an angular deviation of the beam, cause the beam to sweep out an angular subtense, generate a beam from an apex of a cone, or generate a beam at an angle from a point, such that the beam irradiates a plurality of scattering planes in the material.

The optical (e.g., diffracting) element can diffract EM radiation to form a rotating beam of the diffracted EM radiation, the rotating beam irradiating a surface of a material at an oblique angle with respect to the surface and irradiating a plurality of scattering planes in the material.

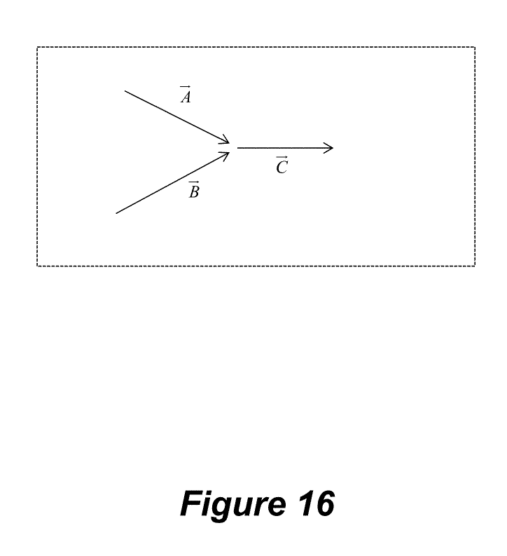

The scattering planes can comprise one or more scattering planes each defined as a plane 1600 that contains the one or more wave vectors (e.g., \vec{A}, \vec{B}) of all incident beams of the deviated EM radiation and one or more wave vectors (e.g., \vec{C}) comprising the sum and/or difference of the wave vectors of the incident beams, as illustrated in FIG. 16. The sum and/or difference can include the sum and/or difference of the incident wavevector with itself (optical rectification) or with different incident wavevectors (harmonic generation).

Throughout this disclosure, optical wavelengths means all or any wavelengths of EM radiation (e.g., including but not limited to visible, infrared, ultraviolet wavelengths, etc.). The optical element can be selected for any desired wavelength of EM radiation, or depending on and to deviate any desired wavelength of EM radiation. Thus, one or more embodiments of the invention are not limited to particular wavelengths of EM radiation.

Possible Modifications and Variations

The techniques used to produce the images in FIG. 4 may be refined to perform an NHG-RA experiment in microscopy mode that combines the demonstrated advantages of our approach with diffraction-limited spatial resolution. This can facilitate the search for lattice, magnetic and even more exotic electronically ordered domains in a crystal. Given that our technique uses ultrashort laser pulses, it can also be implemented as a time resolved pump-probe experiment by introducing a pump beam with a variable time delay. This will allow real-time observation of lattice or electronic symmetry changes following photo-excitation that can lead to a more detailed understanding of the coupling between lattice and electronic degrees of freedom in a crystal. There is also the possibility of directly observing the symmetry of coherently generated collective modes by measuring the time resolved symmetry variations in the RA patterns following photo-excitation. These may include normal modes of lattice, magnetic or other electronic orders, such as spin and charge density waves.

Advantages and Improvements

Nonlinear optical generation from a crystalline material can reveal the symmetries of both its lattice structure and underlying ordered electronic phases and can therefore be exploited as a complementary technique to diffraction based scattering probes. For example, nonlinear optical rotational anisotropy spectroscopy is a well established technique for measuring the crystallographic symmetry of thin film metals and semiconductors. Over the past two decades, sensitivity to the symmetries of ferromagnetic, antiferromagnetic and ferroelectric phases in thin films, multilayer heterostructures and large area bulk single crystals have also been demonstrated. It is therefore a powerful structure refinement tool that is highly complementary to diffraction based probes.

However, owing to the need to rotate the crystal with respect to the light scattering plane during measurement, application of nonlinear optical rotational anisotropy spectroscopy is restricted to materials with large (at least several mm) flat areas that have large tolerance to alignment errors. This technique currently cannot be used to study complex electronic phases small (sub-mm) bulk single crystals, including many interesting strongly correlated d- and f-electron based systems, or to interrogate their small micron sized domains. An even greater technical challenge arises if low temperature, high magnetic field or high strain/pressure environments are required because expensive rotating apparatus must then be included.

The present invention describes a novel instrument that overcomes the need for a rotating crystal by instead creating a rotating light scattering plane. The NHG-RA spectrometer according to one or more embodiments and developed and described here also resolves previous technical challenges associated with beam walking on the sample and precession of the sample normal with respect to the sample rotation axis. Thus, the setup according to one or more embodiments of the invention allows an unprecedented alignment accuracy that enables experiments to be carried out on sample areas down to a few micron length scale while easily accommodating low temperature, magnetic or strain field environments.

In addition to extending nonlinear optical rotational anisotropy spectroscopy to small bulk single crystals, the instrument according to one or more embodiments of the invention is also compact and able to be assembled using inexpensive and commercially available optical and mechanical components.

### REFERENCES

The following references are incorporated by reference herein.

[1] J. F. Nye, Physical properties of crystals. Oxford: Clarendon Press (1957).

[2] R. R. Birss, Symmetry & Magnetism. Amsterdam: North- Holland Publishing Company (1966).

[3] B. E. Warren, X-ray diffraction. New York: Dover Publications Inc. (1991).

[4] G. L. Squires, Introduction to the theory of thermal neutron scattering. Cambridge University Press (1978).

[5] X. Zou, S. Hovmoller & P. Oleynikov, Electron crystallography: Electron microscopy and electron diffraction. Oxford University Press (2011).

[6] Y. Murakami et al., “Resonant x-ray scattering from orbital ordering in LaMnO3,” Phys. Rev. Lett. 81, 582 (1998).

[7] P. Santini et al., “Multipolar interactions in f-electron systems: The paradigm of actinide dioxides,” Rev. Mod. Phys. 81, 807 (2009).

[8] Y. Kuramoto, H. Kusunose, & A. Kiss, “Multipole orders and fluctuations in strongly correlated electron systems,” J. Phys. Soc. Jpn. 78, 072001 (2009).

[9] Y. R. Shen, The principles of nonlinear optics. Wiley (2003).

[10] R. W. Boyd, Nonlinear optics. Academic Press (1991).

[11] H. W. K. Tom, T. F. Heinz & Y. R. Shen, “Second-harmonic reflection from silicon surfaces and its relation to structural symmetry,” Phys. Rev. Lett. 51, 1983 (1983).

[12] S. A. Yang, X. Li, A. D. Bristow & J. E. Sipe, “Second harmonic generation from tetragonal centrosymmetric crystals,” Phys. Rev. B 80, 165306 (2009).

[13] R.-P. Pan, H. D. Wei & Y. R. Shen, “Optical second-harmonic generation from magnetized surfaces,” Phys. Rev. B 39, 1229 (1989).

[14] A. Dahn, W. Hubner & K. H. Bennemann, “Symmetry analysis of the nonlinear optical response: Second harmonic generation at surfaces of antiferromagnets,” Phys. Rev. Lett. 77, 3929 (1996).

[15] M. Fiebig, V. V. Pavlov & R. V. Pisarev, “Second-harmonic generation as a tool for studying electronic and magnetic structures of crystals: review,” JOSA B 22, 96 (2005).

[16] A. Kirilyuk & T. Rasing, “Magnetization-induced-secondharmonic generation from surfaces and interfaces,” JOSA B 22, 148 (2005).

[17] J. E. Sipe, D. J. Moss & H. M. van Driel, “Phenomenological theory of second- and third-harmonic generation from cubic centrosymmetric crystals,” Phys. Rev. B 35, 1129 (1987).

[18] Y. R. Shen, “Optical second harmonic generation at interfaces,” Ann. Rev. Phys. Chem. 40, 327 (1989).

[19] M. Fiebig, D. Frohlich, B. B. Krichevtsov & R. V. Pisarev, “Second harmonic generation and magnetic-dipole-electric-dipole interference in antiferromagnetic Cr2O3,” Phys. Rev. Lett. 73, 2127 (1994).

[20] V. N. Gridnev, V. V. Pavlov, R. V. Pisarev, A. Kirilyuk & T. Rasing, “Second harmonic generation in anisotropic magnetic films,” Phys. Rev. B 63, 184407 (2001).

[21] M. Fiebig et al., “Second harmonic generation in the centrosymmetric antiferromagnet NiO,” Phys. Rev. Lett. 87, 137202 (2001).

[22] M. Lafrentz et al., “Optical third harmonic generation in the magnetic semiconductor EuSe,” Phys. Rev. B 85, 035206 (2012).

[23] M. Fiebig etal., “Determination of magnetic symmetry of hexagonal manganites by second harmonic generation,” Phys. Rev. Lett. 84, 5620 (2000).

[24] A. Kumar et al., “Linear and nonlinear optical properties of BiFeO3,” Appl. Phys. Lett. 92, 121915 (2008).

[25] T. F. Heinz, M. M. T. Loy & W. A. Thompson, “Study of Si(111) surfaces by optical second-harmonic generation: Reconstruction and surface phase transformation,” Phys. Rev. Lett. 54, 63 (1985).

[26] H. W. K. Tom & G. D. Aumiller, “Observation of rotational anisotropy in the second-harmonic generation from a metal surface,” Phys. Rev. B 33, 8818 (1986).

[27] J. C. Petersen et al., “Nonlinear optical signatures of the tensor order in Cd2Re2O7,” Nat. Phys. 2, 605 (2006).

[28] Y. Hirata et al., “Mechanism of enhanced optical secondharmonic generation in the conducting pyrochlore-type Pb2Ir2O7— x oxide compound,” Phys. Rev. Lett. 110, 187402 (2013).

[29] A. G. Banshchikov et al., “Generation of second optical harmonic and magnetooptical Kerr effect in ferromagnet-semiconductor heterostructures CaF2/MnAs/Si(111),” Physics of the Solid State 42, 909 (2000).

[30] K. Sato et al., “Anisotropic magnetization-induced second harmonic generation in Fe/Au superlattices,” Phys. Rev. B 64, 184427 (2001).

[31] L. R. Shelford et al., “Magnetic second harmonic generation at the Co2MnSi/AlOx interface,” J. Appl. Phys. 103, 07D720 (2008).

[32] S.-H. Kim et al., “Enhancement of saturation magnetization in epitaxial (111) BiFeO3 films by magnetic annealing,” Thin Solid Films 517, 2749 (2009).

[33] Y. Q. An, J. E. Rowe, D. B. Dougherty, J. U. Lee & A. C. Diebold, “Optical second harmonic generation induced by electric current in graphene on Si and SiC substrates,” Phys. Rev. B 89, 115310 (2014).

[34] D. Hsieh et al., “Nonlinear optical probe of tunable surface electrons on a topological insulator,” Phys. Rev. Lett. 106, 057401 (2011).

[35] M. Nyvlt, F. Bisio & J. Kirschner. “Second harmonic generation study of the antiferromagnetic NiO(001) surface,” Phys. Rev. B 77, 014435 (2008). [36] Y. Ogawa et al., “Enhanced lattice polarization in SrTiO3/LaAlO3 superlattices measured using optical secondharmonic generation,” Phys. Rev. B 80, 081106(R) (2009).

[37] Y.M. Sheu et al., “Photoinduced stabilization and enhancement of the ferroelectric polarization in Ba0.1Sr0.9TiO3/La0.7Ca(Sr)0.3MnO3 thin film heterostructures,” Phys. Rev. B 88, 020101(R) (2013).

[38] D. H. Torchinsky, J. A. Johnson & K. A. Nelson. “A direct test of the correlation between elastic parameters and fragility of ten glass formers and their relationships to elastic models of the glass transition,” J. Chem. Phys. 130, 064502 (2009).

[39] B. Quesnel & P. Mora. “Theory and simulation of the interaction of ultraintense laser pulses with electrons in vacuum,” Phys. Rev. E 58, 3719 (1998).

[40] S. Carrasco, B. E. A. Saleh, M. C. Teich & J. T. Fourkas. “Second- and third-harmonic generation with vector Gaussian beams,” JOSA B 23, 2134 (2006).

[41] G. Cao, J. Bolivar, S. McCall, J. E. Crow & R. P. Guertin, “Weak ferromagnetism, metal-to-nonmetal transition, and negative differential resistivity in single-crystal Sr2IrO4,” Phys. Rev. B 57, R11039 (1998).

[42] F. Ye. et al., “Magnetic and crystal structures of Sr2IrO4: A neutron diffraction study” Phys. Rev. B 87, 140406 (2013).

[43] C. Dhital et al., “Neutron scattering study of correlated phase behavior in Sr2IrO4′” Phys. Rev. B 87, 144405 (2013).

[44] S. Boseggia et al., “Antiferromagnetic order and domains in Sr3Ir2O7 probed by x-ray resonant scattering,” Phys. Rev. B 85, 184432 (2012).

[45] M. K. Crawford et al., “Structural and magnetic studies of Sr2IrO4,” Phys. Rev. B 49, 9198 (1994).

[46] Q. Huang et al., “Neutron powder diffraction study on the crystal structures of Sr2RuO4 and Sr2IrO4 at room temperature and at 10 K,” J. Sol. State Chem. 112, 355 (1994).

[47] Power point slides by Lauren Niu, Antoni Woss, John Harter, Darius Torchinsky, David Hsieh, ’ entitled “High-speed nonlinear optical harmonic generation rotational anisotropy measurements for sensitive detection of crystallographic and electronic symmetry breaking” presented at APS March Meeting (March 2015) in San Antonio Tex. (Abstract: S21.00014).

[48] Abstract: S21.00014 : High speed nonlinear optical harmonic generation rotational anisotropy measurements for sensitive detection of crystallographic and electronic symmetry breaking, http://meetings.aps.org/link/BAPS.2015.MAR.S21.14, by Lauren Niu, Antoni Woss, John Harter, Darius Torchinsky, David Hsieh

[49] D. H. Torchinsky, H. Chu, T. Qi, G. Cao and D. Hsieh, Rev. Sci. Instrum. 85, 083102 (2014).

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for measuring Electromagnetic (EM) radiation scattered by a material, comprising:
rotating one or more beams of EM radiation to form one or more rotating beams;
irradiating a surface of a material with the one or more rotating beams at one or more oblique angles with respect to the surface, wherein the rotating of each the beams irradiates a plurality of scattering planes in the material; and
detecting, in a detector, radiation scattered by the material in response to the one or more rotating beams.

2. The method of claim 1, wherein the radiation scattered by the material is generated by one or more nonlinear processes.

3. The method of claim 1, wherein the detecting comprises rotating a detector such that the radiation generated by each of the scattering planes is detected by the detector.

4. The method of claim 1, wherein the method is performed while the material is stationary.

5. The method of claim 1, further comprising polarizing the one or more beams such that at least two polarization directions of the beam are selected and such that the radiation is detected for each of the polarization directions.

6. The method of claim 1, wherein the one or more rotating beams draw at least a portion of a cone and the detector is rotated to track the displacement of the nonlinear radiation.

7. The method of claim 1, further comprising:
diffracting EM radiation, using one or more diffraction gratings, to form the one or more beams comprising one or more diffracted beams of radiation, wherein the rotating comprises rotating the one or more diffraction gratings such that the one or more rotating beams comprise one or more rotating diffracted beams.

8. The method of claim 1, wherein the one or more beams are rotated such that beam walk on the material is 1 μm or less and deviation of the surface's normal away from the rotation axis is 0.2° or less when the one or more beams are rotated through 360°.

9. The method of claim 1, wherein the surface has a surface area of 1 mm by 1 mm or less.

10. The method of claim 1, further comprising scanning the one or more beams to one or more locations on the material and illuminating the surface with the one or more rotating beams at one or more of the locations, thereby detecting the radiation generated at one or more of the locations.

11. The method of claim 1, wherein the material is at least one material selected from a transition metal oxide, a semiconductor wafer, graphene, a transition metal dichalcogenide, and a d and f electron based strongly correlated electron system.

12. The method of claim 11, wherein:
the material is the semiconductor wafer,
the radiation scattered by the material is generated by one or more nonlinear processes, and
the radiation is used to differentiate between crystallographic domains in the semiconductor wafer.

13. The method of claim 11, wherein:
the material includes the graphene or the transition metal dichalcogenide,
the radiation scattered by the material is generated by one or more nonlinear processes, and
the radiation is used to differentiate between different crystallographic stacking order in the graphene or the transition metal dichalcogenide.

14. A method of performing a nonlinear harmonic generation rotational anisotropy (NH-GRA) measurement, comprising the steps of claim 1.

15. An apparatus for measuring Electromagnetic (EM) radiation scattered by a material, comprising:
one or more optical elements, wherein the optical elements rotatably deviate EM radiation from one or more EM sources to form deviated EM radiation; and
a focusing optical element positioned to focus the deviated EM radiation such that the deviated EM radiation irradiates a plurality of scattering planes at a same location on or in the material to form scattered EM radiation; and
wherein the scattered EM radiation can be measured.

16. The apparatus of claim 15, wherein the optical elements are mounted on one or more rotation stages to rotatably deviate the EM radiation.

17. The apparatus of claim 15, wherein the optical elements each comprise a series of differently oriented diffracting structures such that each of the diffracting structures generates a different deviation angle for the EM radiation to irradiate the plurality of scattering planes.

18. The apparatus of claim 15, wherein the scattering planes comprise one or more scattering planes each defined as a plane that contains the one or more wave vectors of all incident beams of the deviated EM radiation and one or more wave vectors comprising a sum and/or difference of the wave vectors of the incident beams.

19. The apparatus of claim 15, further comprising a detector mounted on a rotation stage, wherein the rotation stage rotates the detector such that the scattered EM radiation scattered at each of the scattering planes is detected by the detector.

20. The apparatus of claim 15, further comprising a polarizer mounted on a rotation stage, wherein the polarizer can select at least two polarization directions of the EM radiation and the scattered EM radiation is detected for each of the polarization directions.

21. The apparatus of claim 15, wherein the one or more optical elements is aligned such that beam walk on the material is 1 μm or less and deviation of the surface's normal away from the rotation axis is 0.2° or less when the deviated EM radiation is rotated through 360°.

22. A method for fabricating an apparatus for measuring harmonic generation, comprising:
obtaining one or more optical elements comprising one or more diffracting elements, wherein the optical elements can rotatably diffract EM radiation from one or more EM sources, to form deviated EM radiation;
positioning a focusing optical element to focus the deviated EM radiation such that the deviated EM radiation irradiates a plurality of scattering planes at a same location on or in the material to form scattered EM radiation;
aligning the one or more diffracting elements, wherein the aligning comprises:
interfering two diffracted orders of the deviated EM radiation onto the material to form an interference pattern,
observing the fringe contrast of the interference pattern, and
aligning the material with respect to the focusing optical element, and/or aligning the diffracting element with respect to the focusing optical element, based on the fringe contrast and in order to optimize the fringe contrast; and
positioning a detector, wherein the scattered EM radiation scattered by one or more of the scattering planes is detected and measured.
